(19) United States
(12) Patent Application Publication
(10) Pub. No.: US 2008/0127192 A1
(43) Pub. Date: May 29, 2008

(54) Method and System for Using Multiple-Core Integrated Circuits

(76) Inventors: Louis B. Capps, Georgetown, TX (US); Thomas J. Dewkett, Staatsburg, NY (US); Joanne Ferris, Essex, VT (US); Anand Haridass, Austin, TX (US); Ronald E. Newhart, Essex Junction, VT (US); Michael J. Shapiro, Austin, TX (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/466,903

(22) Filed: Aug. 24, 2006

(51) Int. Cl. G06F 9/46

(52) U.S. Cl. 718/103

(57) ABSTRACT

A method, apparatus, and computer program product for using a multi-core integrated circuit having cores with differing performance characteristics. The cores are arranged into high and low performance groups and tasks are assigned according to their priority to either a high or low performance group.

### BACKGROUND

1. Technical Field of the Present Invention

The present invention generally relates to integrated circuits and, more specifically, to integrated circuits having multiple functionally equivalent cores.

2. Description of Related Art

The appetite of the consumer for faster, smaller, and smarter electronic devices has pushed the semiconductor industry to innovate on several different aspects.

One particular area has been the design of processors. In the past, these designs where able to keep pace with the demands of the consumer by increasing the transistor count and the frequency at which the processor operates. Recently, however, the ability to increase this frequency has been limited by current process technology and geometries. As a result, multi-core functional units are now being used as a means to increase processor performance within the imposed frequency limitations. An example of a multi-core processor is the PowerPC™ 970MP by IBM.

Currently, the design and use of these multi-processor cores revolves around the concept that all of the cores must have equivalent performance (e.g., all must operate at 3.2 GHZ). As a result, during manufacture and test, the core having the lowest frequency/performance determines the frequency/performance at which the remaining cores will be forced to operate. This type of forced frequency range unnecessarily increases the cost of the multi-processor cores while wasting valuable resources (i.e., cores that can operate at a higher frequency/performance).

It would, therefore, be a distinct advantage to have a method, apparatus, and computer program product that would use all of the cores in a multi-processor even when they are operating at differing frequencies. This would result in producing higher yields in the manufacturing of the processors and providing systems with the ability to direct high and low priority tasks to those cores capable of handling these tasks within a given time constraint.

### SUMMARY OF THE PRESENT INVENTION

In one aspect, the present invention is a method of using multiple cores in an integrated circuit. The method includes the steps of storing performance data for each one of the cores and characterizing each one of the cores according to the stored performance data. The method also includes the step of assigning tasks to each one of the cores according to their characterization.

### BRIEF DESCRIPTION OF THE DRAWINGS

The present invention will be better understood and its advantages will become more apparent to those skilled in the art by reference to the following drawings, in conjunction with the accompanying specification, in which:

FIG. 1 is a block diagram illustrating a computer system that implements a preferred embodiment of the present invention;

FIG. 2 is a diagram illustrating the processor of FIG. 1 in greater detail according to a preferred embodiment of the present invention;

FIG. 3 is a flow chart illustrating the method used by the scheduler of FIG. 2 to assign tasks to one or more of the cores according to the teachings of a preferred embodiment of the present invention;

FIG. 4 is a flow chart illustrating the method used by the scheduler of FIG. 2 to assign tasks to one or more of the cores according to an alternative preferred embodiment of the present invention.

### DETAILED DESCRIPTION OF THE PREFERRED EMBODIMENT OF THE PRESENT INVENTION

The present invention is a method, system, and computer program product for using multiple cores in an integrated circuit where one or more of the cores has an operating frequency/performance that is different from the remaining cores. Frequency/performance data is gathered during manufacturing and test and used during operation of the cores to direct low and high priority tasks according to the performance data.

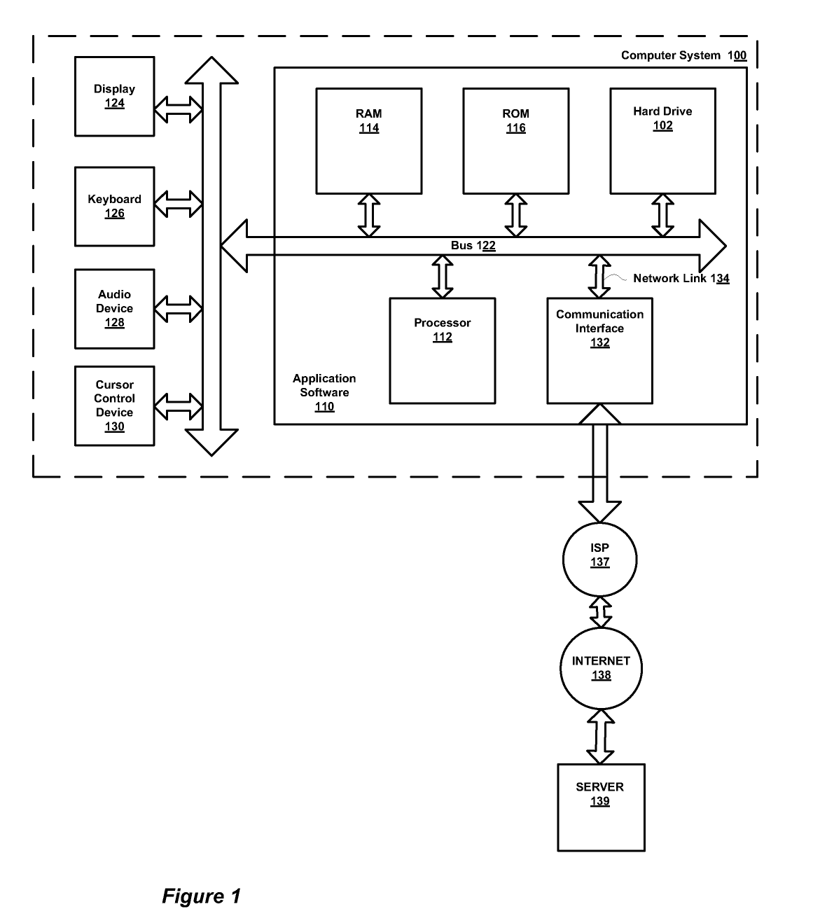

Reference now being made to FIG. 1, a block diagram is shown illustrating a computer system 100 that implements a preferred embodiment of the present invention. Computer System 100 includes various components each of which is explained in greater detail below.

Bus 122 represents any type of device capable of providing communication of information within Computer System 100 (e.g., System bus, PCI bus, cross-bar switch, etc.)

Processor 112 can be a general-purpose processor (e.g., the PowerPC™ 970 manufactured by IBM or the Pentium™ D manufactured by Intel) that, during normal operation, processes data under the control of an operating system and application software 110 stored in a dynamic storage device such as Random Access Memory (RAM) 114 and a static storage device such as Read Only Memory (ROM) 116. The operating system preferably provides a graphical user interface (GUI) to the user.

The present invention, including the alternative preferred embodiments, can be provided as a computer program product, included on a machine-readable medium having stored on it machine executable instructions used to program computer system 100 to perform a process according to the teachings of the present invention.

The term “machine-readable medium” as used in the specification includes any medium that participates in providing instructions to processor 112 or other components of computer system 100 for execution. Such a medium can take many forms including, but not limited to, non-volatile media, and transmission media. Common forms of non-volatile media include, for example, a floppy disk, a flexible disk, a hard disk, magnetic tape, or any other magnetic medium, a Compact Disk ROM (CD-ROM), a Digital Video Disk-ROM (DVD-ROM) or any other optical medium whether static or rewriteable (e.g., CDRW and DVD RW), punch cards or any other physical medium with patterns of holes, a programmable ROM (PROM), an erasable PROM (EPROM), electrically EPROM (EEPROM), a flash memory, any other memory chip or cartridge, or any other medium from which computer system 100 can read and which is suitable for storing instructions. In the preferred embodiment, an example of a non-volatile medium is the Hard Drive 102.

Volatile media includes dynamic memory such as RAM 114. Transmission media includes coaxial cables, copper wire or fiber optics, including the wires that comprise the bus 122. Transmission media can also take the form of acoustic or light waves, such as those generated during radio wave or infrared data communications.

Moreover, the present invention can be downloaded as a computer program product where the program instructions can be transferred from a remote computer such as server 139 to requesting computer system 100 by way of data signals embodied in a carrier wave or other propagation medium via network link 134 (e.g., a modem or network connection) to a communications interface 132 coupled to bus 122.

Communications interface 132 provides a two-way data communications coupling to network link 134 that can be connected, for example, to a Local Area Network (LAN), Wide Area Network (WAN), or as shown, directly to an Internet Service Provider (ISP) 137. In particular, network link 134 may provide wired and/or wireless network communications to one or more networks.

ISP 137 in turn provides data communication services through the Internet 138 or other network. Internet 138 may refer to the worldwide collection of networks and gateways that use a particular protocol, such as Transmission Control Protocol (TCP) and Internet Protocol (IP), to communicate with one another. ISP 137 and Internet 138 both use electrical, electromagnetic, or optical signals that carry digital or analog data streams. The signals through the various networks and the signals on network link 134 and through communication interface 132, which carry the digital or analog data to and from computer system 100, are exemplary forms of carrier waves transporting the information.

In addition, multiple peripheral components can be added to computer system 100. For example, audio device 128 is attached to bus 122 for controlling audio output. A display 124 is also attached to bus 122 for providing visual, tactile or other graphical representation formats. Display 124 can include both non-transparent surfaces, such as monitors, and transparent surfaces, such as headset sunglasses or vehicle windshield displays.

A keyboard 126 and cursor control device 130, such as mouse, trackball, or cursor direction keys, are coupled to bus 122 as interfaces for user inputs to computer system 100.

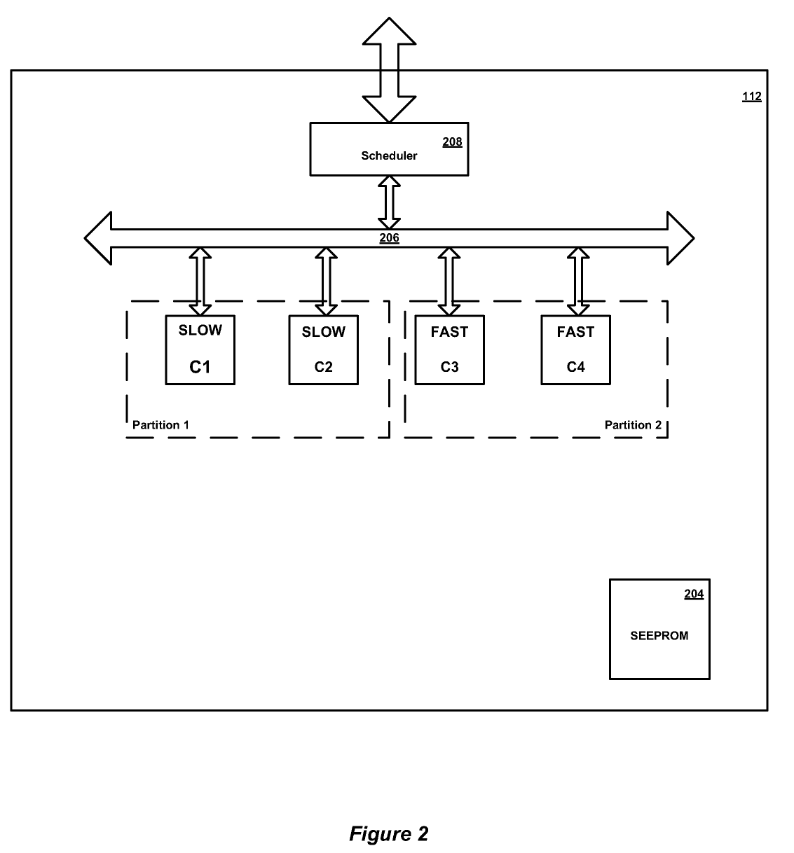

Reference now being made to FIG. 2, a diagram is shown illustrating the processor 112 of FIG. 1 in greater detail according to a preferred embodiment of the present invention. It should be noted that although the preferred embodiment of the present invention uses a processor 112, the present invention is not limited to this embodiment, but is equally applicable to any device that has multiple equivalent functional units.

Processor 112 is a multi-core processor having numerous components whose function and operation are well known and understood. Consequently, only those components that are deemed to require further explanation as they are used in the present invention are illustrated and discussed. Processor 112 includes a scheduler 208, an internal bus 206, cores C1 to C4, and a Serial Electrically Erasable Programmable Read-Only-Memory (SEEPROM) 204.

In the preferred embodiment of the present invention, processor 112 is shown as having four cores C1-C4. This embodiment is not intended to limit the number of cores that can reside within processor 112 but as a convenient means for explaining the present invention. In fact, the number of cores that can reside in processor 112 can be numerous and are typically dictated by the design of the computer system 100.

SEEPROM 204 is used to store performance data for each one of the cores C1-C4 that is typically generated during manufacture and test. The performance data can include information such as the frequency at which the core C1-C4 is capable of operating and/or power requirements. Although a SEEPROM 204 is used in the preferred embodiment of the present invention, any memory or other storage device that is capable of storing and retaining the performance data when power is turned-off to the processor 112 would be applicable to the present invention (e.g., a fuse or stored elsewhere within computer system 100).

Scheduler 208 represents the interface to bus 122 (FIG. 1) and is responsible for managing and assigning tasks/instructions to one or more of the cores C1-C4 as they are received via internal bus 206. The method of assigning tasks described in connection with scheduler 208 can be embodied and performed by either hardware or software and, as such, can reside in the processor 112 itself (as shown), in any other component of computer system 112, application software 110, operating system, hypervisor, or any combination thereof.

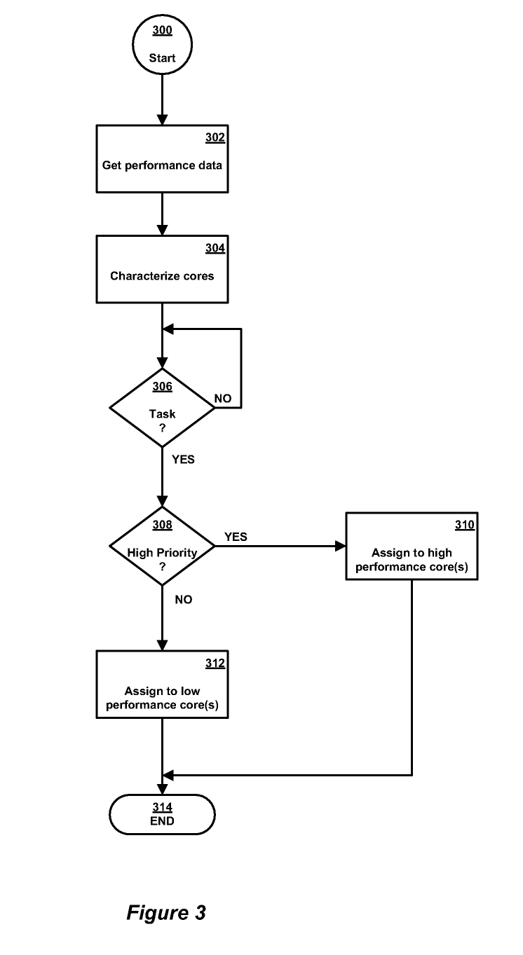

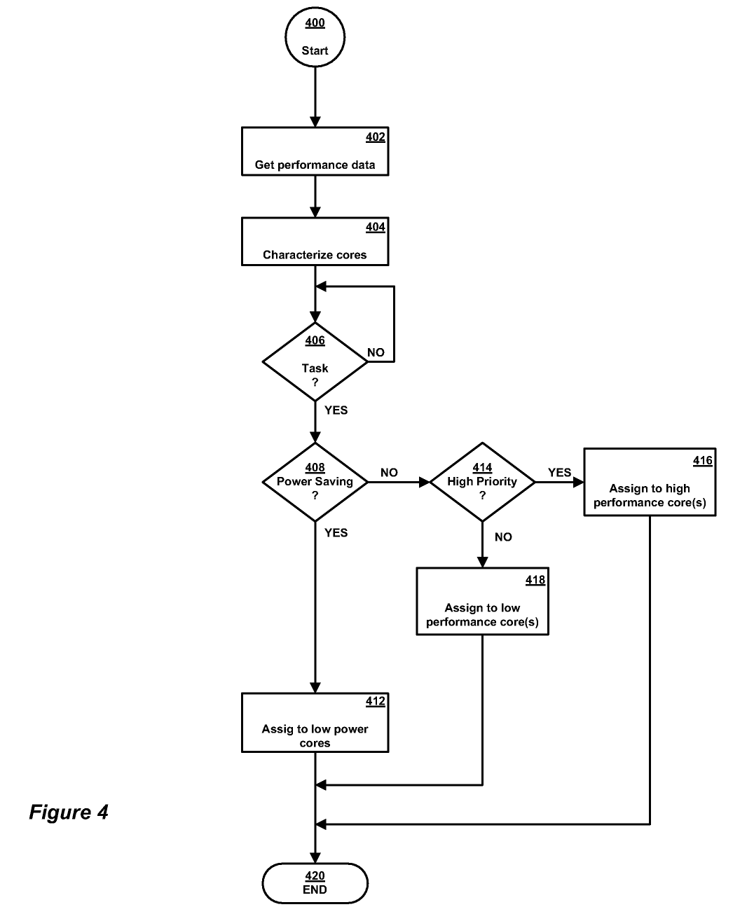

In the preferred embodiment of the present invention, scheduler 208 retrieves the performance data for each one of the cores C1-C4 from the SEEPROM 204 and uses the data to determine how to route tasks to the cores C1-C4 as explained in connection with FIGS. 3 and 4.

Reference now being made to FIG. 3, a flow chart is shown illustrating the method used by the scheduler 208 of FIG. 2 to assign tasks to one or more of the processors C1-C4 according to the teachings of a preferred embodiment of the present invention. Scheduler 208 retrieves the performance data from the SEEPROM 204 for each of the cores C1-C4 and characterizes the cores according to their data (steps 300-304). For the moment, it can be assumed that cores C1-C2 are categorized according to the performance data as being capable of processing tasks in a time period that is considered slower than ideal (i.e., “slow”) and cores C3-C4 are categorized as processing tasks in a time period that is considered ideal (i.e., “fast”).

As scheduler 208 receives tasks, it can determine the relative priority of each task and based upon this assign low priority tasks to lower performance cores C1-C2 and high tasks to high performance cores C3-C4 (steps 308-314).

In an alternative embodiment of the present invention, the performance data stored in the SEEPROM 204 is read by firmware and provided to a task manager such as a hypervisor (e.g., for mainframes and the like) that uses the data to partition the processor 112. For purposes of discussion, it can be assumed that a hypervisor has created a partition 1 for slow cores C1-C2 and partition 2 for fast cores C3-C4. High priority tasks are directed to the fast partition 2 and low priority tasks to the slow partition 1.

In yet another alternative embodiment, firmware or other similar type managers can use the lower performance cores C1-C2 to perform low priority tasks such as I/O assist processors, utility partition processors or other special purposes engines (e.g., auxiliary engines).

Reference now being made to FIG. 4, a flow chart is shown illustrating the method used by the scheduler 208 to assign tasks to one of the cores C1-C2 according to an alternative preferred embodiment of the present invention. Scheduler 208 retrieves the performance data from the SEEPROM 204 for each of the cores C1-C4 and characterizes the cores according to their data (steps 400-404). Cores C1-C2 are categorized according to the performance data as being low power cores (i.e., they are optimized to perform tasks while consuming a small amount of power) and cores C3-C4 are categorized as high power cores (i.e., they are optimized for performance and consume more power than cores C1-C2).

Scheduler 208 then determines whether a power savings mode has been invoked by either the user or computer system 100. A power savings mode can be invoked as a result of an emergency, or part of a power savings initiative where during certain periods of operation (e.g., day or peak-power costs) the power savings mode is invoked (Step 408).

If power savings has been invoked, then the scheduler 208 can turn-off the high power cores (e.g., C2-C4) or optionally route all tasks to the low power cores (e.g., C1-C2) (Steps 412-414).

If, however, power savings has not been invoked, then the scheduler 208 can determine the relative priority of each task and based upon this assign low priority tasks to lower performance cores C1-C2 and high tasks to high performance cores C3-C4 (steps 414-418).

It is thus believed that the operation and construction of the present invention will be apparent from the foregoing description. While the method and system shown and described has been characterized as being preferred, it will be readily apparent that various changes and/or modifications could be made without departing from the spirit and scope of the present invention as defined in the following claims.

What is claimed is:

1. A method of using multiple cores in an integrated circuit, the method comprising the steps of:
storing performance data for each one of the cores;
characterizing each one of the cores according to the stored performance data;
assigning tasks to each one of the cores according to their characterization.

2. The method of claim 1 wherein the step of characterizing includes the step of:
characterizing one or more cores as low performance cores and one or more cores as high performance cores.

3. The method of claim 2 further comprising the step of:
receiving tasks each having an associated priority indication.

4. The method of claim 3 wherein the step of assigning tasks includes the step of:
assigning low priority tasks to the low performance cores; and
assigning high priority tasks to the high performance cores.

5. The method of claim 1 wherein the step of characterizing includes the step of:
characterizing one or more cores as low power cores and one or more cores as high power cores.

6. The method of claim 5 further comprising the step of:
detecting a power savings indication.

7. The method of claim 6 wherein the step of assigning tasks includes the step of:
assigning all tasks to the one or more low power cores in response to detecting the power savings indication.

8. An apparatus for using multiple cores in an integrated circuit, the apparatus comprising:
means for storing performance data for each one of the cores;
means for characterizing each one of the cores according to the stored performance data;
means for assigning tasks to each one of the cores according to their characterization.

9. The apparatus of claim 8 wherein the means for characterizing includes:
means for characterizing one or more cores as low performance cores and one or more cores as high performance cores.

10. The apparatus of claim 9 further comprising:
means for receiving tasks each having an associated priority indication.

11. The apparatus of claim 10 wherein the means for assigning tasks includes:
means for assigning low priority tasks to the low performance cores; and
means for assigning high priority tasks to the high performance cores.

12. The apparatus of claim 8 wherein the means for characterizing includes:
means for characterizing one or more cores as low power cores and one or more cores as high power cores.

13. The apparatus of claim 12 further comprising:
means for detecting a power savings indication.

14. The apparatus of claim 13 wherein the means for assigning tasks includes:
means for assigning all tasks to the one or more low power cores in response to detecting the power savings indication.

15. A computer program product comprising a computer usable medium having computer usable program code for using multiple cores in an integrated circuit, the computer usable program code comprising:
computer usable program code for storing performance data for each one of the cores;
computer usable program code for characterizing each one of the cores according to the stored performance data;
computer usable program code for assigning tasks to each one of the cores according to their characterization.

16. The computer program product of claim 15 wherein the computer usable program code for characterizing includes:
computer usable program code for characterizing one or more cores as low performance cores and one or more cores as high performance cores.

17. The computer program product of claim 16 wherein the computer usable program code further comprises:
computer usable program code for receiving tasks each having an associated priority indication.

18. The computer program product of claim 17 wherein the computer usable program code for assigning tasks includes:
computer usable program code for assigning low priority tasks to the low performance cores; and
computer usable program code for assigning high priority tasks to the high performance cores.

19. The computer program product of claim 15 wherein the computer usable program code for characterizing includes:
computer usable program code for characterizing one or more cores as low power cores and one or more cores as high power cores.

20. The computer program product of claim 19 wherein the computer usable program code for assigning tasks includes:
computer usable program code for assigning all tasks to the one or more low power cores in response to detecting a power savings indication.
